(19) United States
(12) Patent Application Publication
(10) Pub. No.: US 2024/0087876 A1
(43) Pub. Date: Mar. 14, 2024

(54) ANALYTICAL INSTRUMENT WITH ION TRAP COUPLED TO MASS ANALYSER

(71) Applicant: Thermo Fisher Scientific (Bremen) GmbH, Bremen (DE)

(72) Inventors: Hamish STEWART, Bremen (DE); Dmitry GRINFELD, Bremen (DE)

(73) Assignee: Thermo Fisher Scientific (Bremen) GmbH, Bremen (DE)

(21) Appl. No.: 18/467,401

(22) Filed: Sep. 14, 2023

(30) Foreign Application Priority Data
Sep. 14, 2022 (GB) 2213477.9

(51) Int. Cl. H01J 49/42

(52) U.S. Cl. CPC H01J 49/4225

(57) ABSTRACT

An analytical instrument comprises a mass analyser and first and second ion traps coupled to the mass analyser. A method of operating the instrument comprises operating the first ion trap in a mode of operation in which the first ion trap confines ions within a first mass-to-charge ratio (m/z) range, storing first ions in the first ion trap, operating the second ion trap in a mode of operation in which the second ion trap confines ions within a second different mass-to-charge ratio (m/z) range, and storing second ions in the second ion trap. The method further comprises ejecting the first ions from the first ion trap into the mass analyser, ejecting the second ions from the second ion trap into the mass analyser, and mass analysing the first ions and the second ions.

### CROSS REFERENCE TO RELATED APPLICATIONS

This application claims priority from application GB2213477.9, filed Sep. 14, 2022. The entire disclosure of application GB2213477.9 is incorporated herein by reference.

### FIELD OF THE INVENTION

The present invention relates to the field of mass spectrometry, and in particular to mass spectrometers that include an ion trap, wherein packets of ions are accumulated in the ion trap before being ejected from the ion trap into a mass analyser for analysis.

### BACKGROUND

Mass spectrometers typically include an ion source and a mass analyser configured to analyse ions generated by the ion source. In mass spectrometers that include a time-of-flight (ToF) mass analyser and/or an Orbitrap™ mass analyser, analyte ions generated by the ion source are injected into the mass analyser. Ions can be injected into a mass analyser using a number of techniques, including for example, orthogonal extraction, laser desorption, or extraction from an RF ion trap.

Extraction from an ion trap is used in commercial Orbitrap™ instruments from Thermo Fisher Scientific and in some commercial ToF instruments. Typically, a quadrupole ion trap is used to generate a well-defined ion packet with minimised spatial and energy spreads. U.S. Pat. No. 7,425,699 describes an analytical instrument comprising an ion trap and an Orbitrap™ mass analyser.

U.S. Pat. No. 6,933,498 proposes arrayed analytical ion traps, where a planar array of small cylindrical traps is used to solve dynamic range problems that occur with miniaturisation. U.S. Pat. No. 8,373,120 proposes an arrayed trapping region for a ToF analyser, formed by mesh like structures, for miniaturisation and spreading ions out over a thin sheet for improved space charge performance. U.S. Pat. No. 7,217,919 describes an arrangement in which a single mass analyser is shared between an array of ion sources to allow multiplexed experiments.

It is believed that there remains scope for improvements to apparatus and methods for mass analysis.

### SUMMARY

A first aspect provides a method of operating an analytical instrument, such as a mass spectrometer, the analytical instrument comprising:

a mass analyser;

a first ion trap coupled to the mass analyser; and

a second ion trap coupled to the mass analyser;

the method comprising:

operating the first ion trap in a mode of operation in which the first ion trap confines ions having mass-to-charge ratios (m/z) within a first mass-to-charge ratio (m/z) range, and storing first ions in the first ion trap;

operating the second ion trap in a mode of operation in which the second ion trap confines ions having mass-to-charge ratios (m/z) within a second different mass-to-charge ratio (m/z) range, and storing second ions in the second ion trap;

ejecting the first ions from the first ion trap into the mass analyser;

ejecting the second ions from the second ion trap into the mass analyser; and

mass analysing the first ions and the second ions.

The inventors have recognised that conventional ion trap-mass analyser arrangements can suffer disadvantages. In particular, the ability of an ion trap to trap and store ions is highly dependent on the mass to charge ratios (m/z) of the ions. The trapping pseudopotential well depth falls with increasing m/z, causing an increase in the radius of the ion cloud, and ions of too low m/z cannot be trapped at all because of the low-mass cut-off effect.

Embodiments provide an analytical instrument in which two or more ion traps are coupled to a single mass analyser, such that ions from each of the two or more ion traps can be injected into the mass analyser for mass analysis. In operation, the two or more ion traps are operated such that each of the ion traps will confine ions having m/z within a different m/z range. The combination of the two or more different m/z ranges may collectively provide a wider m/z range than any one of the individual m/z ranges alone. Ions are stored in each of the two or more ion traps, ejected therefrom into the mass analyser, and mass analysed by the mass analyser. In this way, the width of the m/z range of ions that can be injected into and analysed by the mass analyser can be significantly increased.

The mass analyser may be an ion trap mass analyser, such as an electrostatic ion trap mass analyser, more particularly an electrostatic orbital mass analyser, such as an Orbitrap™ mass analyser from Thermo Fisher Scientific. Thus, the mass analyser may have an inner electrode arranged along an axis and two outer detection electrodes spaced apart along the axis and surrounding the inner electrode. Ions trapped within the mass analyser may oscillate with a frequency which may depend on their mass-to-charge ratio and which may be detected using image current detection.

Alternatively, the mass analyser may be a time-of-flight (ToF) mass analyser. The ToF mass analyser may comprise an ion path, and an ion detector arranged at the end of the ion path. The first and second traps may be arranged at the start of the ion path. Ions may be ejected from the first and/or second ion trap into the ion path, whereupon the ions may travel along the ion path to the detector. The analyser may be configured to analyse ions by determining arrival times of ions at the detector (i.e., the time taken for ions to travel from an ion trap and to arrive at the detector via the ion path). In some embodiments, the detector may be preceded by a plane corrector.

The ion path may have any suitable form, such as being substantially linear in the case of a linear ToF analyser, or including one or more reflections in the case of a ToF analyser comprising a reflectron or a multi-reflection time-of-flight (MR-ToF) analyser. In particular embodiments, the analyser is a multi-reflection time-of-flight (MR-ToF) analyser, such as a titled-mirror type multi-reflection time-of-flight mass analyser, e.g. of the type described in U.S. Pat. No. 9,136,101, or a single focusing lens type multi-reflection time-of-flight mass analyser, e.g. of the type described in UK patent No. 2,580,089.

The instrument comprises a first ion trap coupled to the mass analyser, and a second different ion trap also coupled to the mass analyser. The instrument may comprise one or more further ion traps coupled to the mass analyser, and so may comprise in total two, three, four, five, or more ion traps coupled to the mass analyser. The first and second ion traps (and where present the one or more further ion traps) may together form an ion trap array, with each trap of the array being coupled to the mass analyser.

Where present, each further ion trap may be operated in a corresponding manner to the first and/or second ion trap. Thus, for example, the method may comprise operating a third ion trap in a mode of operation in which the third ion trap confines ions having mass to charge ratios within a third m/z range, and storing third ions in the third ion trap. The method may comprise ejecting the third ions from the third ion trap into the mass analyser, and mass analysing the third ions. The third m/z range may be different from both the first and second m/z ranges, i.e. such that the combination of the first, second and third m/z ranges collectively provides a wider m/z range than the combination of the first and second m/z ranges alone. A fourth ion trap may be operated in a corresponding manner, and so on.

Each of the ion traps may be any suitable trap such as an RF ion trap, e.g. a linear RF ion trap or a curved RF ion trap (C-trap). In general, each ion trap may comprise a plurality of electrodes, wherein one or more voltages (comprising one or more RF voltages and optionally one or more DC voltages) may be applied to one or more or each electrode so as to produce a suitable electric field(s) that acts to confine ions within the ion trap. Each trap may be elongated in an axial direction (thereby defining a trap axis), wherein ions can enter the trap in the axial direction, e.g. via an entrance aperture. Each trap may also have an extraction aperture. Thus, each ion trap may be referred to as an extraction trap. Packets of ions accumulated within the trap may be ejected into the mass analyser in an extraction direction via the extraction aperture. This may be achieved by applying suitable extraction voltages, e.g. pulsed push and pull DC voltages, to the trap. The extraction direction may be orthogonal to the trap axis (and to the axial direction).

The ion traps of the ion trap array may be arranged in any suitable manner such that ions from each of the traps can be injected into the mass analyser for mass analysis. In general, there are three possible configurations for the array (although these may be combined).

In a first configuration, the array of traps is arranged in a “parallel” array. In these embodiments, the trap axis of the first trap is aligned with the trap axis of the second trap (and, where present, with each trap axis of each further trap), and the extraction direction of the first trap is parallel to the extraction direction of the second trap (and, where present, to each extraction direction of each further trap). Thus, ions may enter the first trap via the second trap (and, where present, via each further trap), and packets of ions may be ejected from each trap independently of each other trap.

In a second configuration, the array of traps is arranged in an “orthogonal” array. In these embodiments, the trap axis of the first trap is parallel to the trap axis of the second trap (and, where present, to each trap axis of each further trap), and the extraction direction of the first trap is parallel to the extraction direction of the second trap (and, where present, to each extraction direction of each further trap). Thus, ions may enter each trap independently of each other trap, and packets of ions may be ejected from each trap independently of each other trap.

In a third configuration, the array of traps is arranged in a “back-to-back” array. In these embodiments, the trap axis of the first trap is parallel to the trap axis of the second trap (and, where present, to each trap axis of each further trap), and the extraction direction of the first trap is aligned with the extraction direction of the second trap (and, where present, with each extraction direction of each further trap). Thus, ions may enter each trap independently of each other trap, and packets of ions may be ejected from the second trap (and, where present, each further trap) via the first trap.

The method comprises operating each ion trap of the array in a mode of operation in which each ion trap of the array confines ions within a different mass-to-charge ratio (m/z) range. The combination of the different m/z ranges may collectively provide a wider m/z range than any one of the individual m/z ranges. Thus, each m/z range should not be entirely overlapped by another m/z range (and each m/z range should not entirely overlap another m/z range). One or more or each m/z range may partially overlap one or more other m/z ranges, and/or one or more or each m/z range may not overlap any other m/z range. Thus, for example, the first m/z range may partially overlap the second m/z range, or the first and second m/z ranges may be non-overlapping. In some embodiments, the different m/z ranges are all non-overlapping m/z ranges.

Each trap may be configured such that the m/z range of ions that can be confined within the ion trap is controllable (variable). This may be done by controlling (varying) one or more parameters of the one or more voltages applied to the ion trap, such as in particular the amplitude and/or frequency of the RF voltage.

Thus, operating the first ion trap in the mode of operation in which the first ion trap confines ions having m/z within the first m/z range may comprise applying a first set of one or more voltages to the first ion trap such that the first ion trap confines ions having m/z within the first m/z range, and operating the second ion trap in the mode of operation in which the second ion trap confines ions having m/z within the second different m/z range may comprise applying a second set of one or more voltages to the second ion trap such that the second ion trap confines ions having m/z within the second different m/z range.

Where present, operating the third ion trap in the mode of operation in which the third ion trap confines ions having m/z within the third m/z range may comprise applying a third set of one or more voltages to the third ion trap such that the third ion trap confines ions having m/z within the third m/z range.

Where the ion traps of the array are similar or substantially identical ion traps, each set of one or more voltages may be different, such that each m/z range is different. In particular, each set of one or more voltages may include an RF voltage, and the amplitude and/or frequency of the RF voltage may be different for each set. Thus, for example, the first set of one or more voltages may include an RF voltage having a first amplitude and a first frequency, and the second set of one or more voltages may include an RF voltage having a second amplitude and a second frequency. The second amplitude may be different to the first amplitude and/or the second frequency may be different to the first frequency, such that the second m/z range is different to the first m/z range.

The method comprises storing first ions in the first ion trap when the first ion trap is being operated in the mode of operation in which the first ion trap confines ions having m/z within the first m/z range, and storing second ions in the second ion trap when the second ion trap is being operated in the mode of operation in which the second ion trap confines ions having m/z within the second m/z range. Thus, the first ions may be ions having m/z within the first m/z range, and the second ions may be ions having m/z within the second m/z range (and the third ions may be ions having m/z within the third m/z range, etc.).

In embodiments, the instrument comprises an ion source, and the ions stored in each trap are ions produced by the ion source (or are ions derived from the ions produced by the ion source). Ions may be supplied to each trap, and at least some ions received by each ion trap (i.e. those having m/z within the ion trap's m/z range) are stored therein.

In some embodiments, the ions supplied to each trap are unfiltered according to their m/z. However, this may be wasteful, as those ions received by an ion trap having m/z outside the ion trap's m/z range will be lost. Thus, in embodiments, the method comprises separating ions according to their m/z before storing them in the array of ion traps. The instrument may comprise a mass-to-charge ratio (m/z) separator arranged upstream of the array of ion traps, and configured to separate ions (e.g. received from the ion source) according to their m/z. This may allow the instrument to supply ions having m/z within the first m/z range to the first ion trap, and to supply ions having m/z within the second m/z range to the second ion trap (and to supply ions having m/z within the third m/z range to the third ion trap, etc.), i.e. so that fewer ions are lost. In embodiments, the m/z separator may comprise a linear ion trap capable of mass selective ion ejection. The m/z separator may have an ion capacity greater than or equal to the combined ion capacity of all of the traps of the array.

In embodiments, where the trap axis of the first trap is parallel to the trap axis of the second trap (and optionally to the trap axis of each further ion trap) (i.e. in the orthogonal and back-to-back configurations), the first and second (and optionally further) ion traps may be supplied with ions via a branched ion guide, such as a branched RF ion guide of the type described in U.S. Pat. No. 7,829,850. This allows ions from a single source to be distributed to each of the two or more traps of the array.

Where the trap axis of the first trap is aligned with the trap axis of the second trap (and optionally with the trap axis of each further ion trap) (i.e. in the parallel configuration), the first ion trap may be supplied with ions via the second ion trap (and, where a third trap is present, the first ion trap may be supplied with ions via the second and third ion traps, and the second ion trap may be supplied with ions via the third ion trap, etc.). In these embodiments, the array of traps should be filled with ions in sequence. Thus, the method may comprise storing first ions in the first trap, and then storing second ions in the second trap (and where a third ion trap is present and is arranged in the parallel configuration, the method may comprise then storing third ions in the third trap, and so on).

In these embodiments, when the first ion trap is being supplied with ions via the second ion trap, the second ion trap may be operated in a mode of operation in which ions are transmitted by the second ion trap. Once the first ion trap has been filled with ions, then the second ion trap may be switched to operate in the mode of operation in which ions are confined within the second ion trap. Similarly, where a third ion trap is present, when the first ion trap is being supplied with ions via the second and third ion traps, the second and third ion traps may be operated in a mode of operation in which ions are transmitted by the second and third ion traps. Once the first ion trap has been filled with ions, then the second ion trap may be switched to operate in a mode of operation in which ions are trapped within the second ion trap, and the second ion trap may be filled with ions. Once the second ion trap has been filled with ions, then the third ion trap may be switched to operate in a mode of operation in which ions are trapped within the third ion trap.

The method comprises ejecting the stored first ions from the first ion trap into the mass analyser, and ejecting the stored second ions from the second ion trap into the mass analyser (and optionally ejecting the stored ions from each further ion trap into the mass analyser). The steps of storing ions in each trap of the array and then ejecting the ions from each trap of the array into the mass analyser may be performed repeatedly, e.g. periodically. Thus, the method may comprise repeatedly (e.g. periodically): (i) storing ions in each trap of the array; and then (ii) ejecting the stored ions from each trap of the array into the mass analyser.

In embodiments, ions stored in each trap may be cooled before they are ejected into the mass analyser. Thus, for example, the first ions may be cooled in the first ion trap before they are ejected into the mass analyser, and the second ions may be cooled in the second ion trap before they are ejected into the mass analyser. Ions may be stored in each trap for any suitable amount of time so that they are cooled before being ejected into the mass analyser. Thus, the method may comprise repeatedly (e.g. periodically): (i) storing ions in each trap of the array; (ii) cooling the stored ions; and then (ii) ejecting the cooled ions from each trap of the array into the mass analyser.

In these embodiments, in the parallel configuration, during each repeated cycle there may be a time period during which ions cannot be stored in an ion trap of the array, e.g. at least during the time in which ions are being cooled in each trap. Where ions are continuously produced by the ion source, this may mean that ions are wasted. To address this, an array of trapping regions may be provided upstream of the ion trap array, and ions may be initially stored in the array of trapping regions, before being transferred to the ion trap array.

Thus, in embodiments, the instrument comprises an array of trapping regions upstream of the ion trap array. The array of trapping regions may include one trapping region per ion trap of the ion trap array. Thus, the array of trapping regions may comprise at least a first trapping region and a second trapping region (and optionally a third trapping region, and so on). The method may comprise storing first ions in the first trapping region, and then storing second ions in the second trapping region (and optionally then storing third ions in the third trapping region, and so on). The method may comprise then transferring the first ions to the first ion trap, and transferring the second ions to the second ion trap (and optionally transferring the third ions to the third ion trap, and so on). The method may then comprise cooling the first ions in the first ion trap and cooling the second ions in the second ion trap (and optionally cooling the third ions in the third ion trap, and so on), while at the same time storing further ions in the first and second (and optionally third) trapping regions. The ions may be ejected from the first and second (and optionally third) ion traps into the mass analyser at the same time as the further ions are transferred from the array of trapping regions into the array of ion traps. These steps may be repeated periodically.

Each ion trap of the array is coupled to the mass analyser such that packets of ions can be ejected from each ion trap into the mass analyser for analysis. Each trap may be coupled to the mass analyser in any suitable manner, e.g. via one or more ion optical devices. The one or more ion optical devices can include any suitable such devices, such as one or more lenses and/or one or more deflectors. One or more lenses may be provided and configured to condition the pulse of ions as it passes from the extraction trap to the mass analyser, e.g. so that it has a suitable form (e.g. shape, energy, etc.) to be properly received by the mass analyser. One or more deflectors may be provided and configured to properly direct the pulse of ions into the mass analyser.

For example, where the mass analyser is an electrostatic ion trap mass analyser, the one or more lenses may comprise, for example, a so-called V-lens, Z-lens and/or focus lens. A deflector may be arranged immediately adjacent to an entrance aperture or slot of the electrostatic ion trap mass analyser, e.g. between the one or more lenses and the (entrance aperture or slot of the) electrostatic ion trap mass analyser. A voltage may be applied to the deflector electrode and may be dynamically altered, e.g. as the ions enter the electrostatic ion trap mass analyser.

Where the mass analyser is a ToF mass analyser such as a multi-reflection time of flight mass analyser (MR-ToF), the one or more ion optical devices may include one or more deflectors in the form of one or more trapezoid shaped or prism-like electrodes arranged adjacent to the ion beam. The deflector may comprise a first trapezoid shaped or prism-like electrode arranged above the ion beam and a second trapezoid shaped or prism-like electrode arranged below the ion beam. The electrode(s) may be angled with respect to the ion beam, such that when suitable (DC) voltage(s) is (are) applied to the electrode(s), the resulting electric field induces a deflection in the ion beam.

Where the extraction direction of the first trap is aligned with the extraction direction of the second trap (and optionally with the extraction direction of each further ion trap) (i.e. in the back-to-back configuration), the first and second (and optionally further) traps may be coupled to the mass analyser via the same set of one or more ion optical devices. In these embodiments, a lens may be provided between traps of the array, e.g. between the first and the second traps, and may be configured to ensure that ions extracted from both traps have similar divergence.

In these embodiments, ions may be firstly ejected from the ion trap of the array that is closest to the mass analyser, and then ions may be ejected from the ion trap of the array that is next closest to the mass analyser, and so on. Thus, the method may comprise ejecting the first ions from the first ion trap into the mass analyser, and then ejecting the second ions from the second ion trap via the first ion trap into the mass analyser (and optionally then ejecting third ions from the third ion trap via the first and second ion traps into the mass analyser, and so on).

Where the extraction direction of the first trap is parallel to the extraction direction of the second trap (and optionally to the extraction direction of each further ion trap) (i.e. in the parallel and orthogonal configurations), the first and second traps may be coupled to the mass analyser via respective sets of ion optical devices. The respective sets of ion optical devices may be entirely independent of one another, or may share some (but not all) devices. For example, one or more or each lens may be shared amongst some or all of the traps of the array, but one or more independent deflector(s) may be provided in respect of some or all traps of the array.

In particular embodiments, packets of ions ejected from each trap may be deflected in a different manner to packets of ions ejected from each other trap of the array, i.e. so that, despite their differing starting points, after deflection packets of ions from all of the traps adopt the same or similar trajectories into and/or through the mass analyser.

To achieve this, in embodiments, the instrument comprises one or more first deflectors arranged downstream of the array of traps (and upstream of the mass analyser), and one or more second deflectors arranged downstream of the one or more first deflectors (and upstream of the mass analyser). The one or more second deflectors may be spaced apart from, i.e. may be separate from, the one or more first deflectors. The one or more first and one or more second deflectors may be configured such that at least some ions ejected from one or more traps of the array are initially deflected by the one or more first deflectors, before being deflected by the one or more second deflectors. The deflected ions may then enter the mass analyser.

Each deflector may be configured such that it can cause ions to be deflected by a desired (selected) angle. The angle by which ions are deflected by a deflector may be adjustable, e.g. by adjusting the magnitude of a (DC) voltage(s) applied to the deflector.

In embodiments, the one or more first deflectors may comprise one first deflector in respect of each ion trap of the array. Thus, ions ejected from each trap may be initially deflected by a respective first deflector, before being deflected by the one or more second deflectors and entering the mass analyser.

Alternatively, the one or more first deflectors may not include a deflector for at least one trap of the array, e.g. the first trap. In such embodiments, ions ejected from the first trap may be undeflected after being ejected from the first ion trap and before reaching the one or more second deflectors, and/or before entering the mass analyser. Ions ejected from other traps of the array (e.g. from the second ion trap) may be initially deflected by a respective first deflector, before being deflected by the one or more second deflectors and entering the mass analyser.

In particular embodiments, the one or more second deflectors comprise a single second deflector. In these embodiments, the one or more first deflectors may be configured to cause ions ejected from any one of the traps of the array to travel to the single second deflector. The second deflector may then be configured such that ions received from each respective trap are deflected by a differing amount, such that despite the differing angles at which they are received by the second deflector, after deflection, packets of ions from all traps adopt the same or similar trajectories into and/or through the mass analyser.

In these embodiments, a voltage applied to the second deflector may be switched with appropriate timing, such that ions ejected from each respective trap of the array are deflected by a different amount by the second deflector. Equally, ions may be ejected from each trap with appropriate delay between ejections such that there is sufficient time to switch the voltage applied to the second deflector.

Alternatively, the one or more second deflectors may comprise multiple deflectors, e.g. one second deflector in respect of each ion trap of the array. In these embodiments, where the mass analyser is an electrostatic ion trap mass analyser, the mass analyser may include multiple entrance apertures or slots, with each second deflector arranged adjacent to a respective entrance aperture or slot of the mass analyser. Each deflector may be configured to direct packets of ions received from a respective ion trap of the array into the mass analyser via the corresponding entrance aperture or slot.

Once the ions have been injected into the mass analyser, they are mass analysed by the mass analyser. Ions from each trap of the array may be analysed together (at the same time), i.e. in the same acquisition, or ions from each trap of the array may be analysed separately, i.e. in respective different acquisitions.

Thus, in some embodiments, mass analysing the first ions and the second ions (and optionally the third ions, etc.) may comprise mass analysing the first ions and the second ions (and optionally the third ions, etc.) together (at the same time) in the mass analyser, i.e. the first and second ions (and optionally the third ions, etc.) may be analysed in the same acquisition. Alternatively, mass analysing the first ions and the second ions (and optionally the third ions, etc.) may comprise mass analysing the first ions by injecting the first ions from the first ion trap into the mass analyser, and then mass analysing the second ions by injecting the second ions from the second ion trap into the mass analyser (and optionally then mass analysing the third ions by injecting the third ions from the third ion trap into the mass analyser), i.e. the first and second ions (and optionally the third ions, etc.) may be analysed separately in respective acquisitions.

A further aspect provides a method of operating an analytical instrument that comprises:

a time-of-flight mass analyser comprising an ion path, and an ion detector arranged at the end of the ion path;

a first ion trap coupled to the mass analyser; and

a second ion trap coupled to the mass analyser, wherein the first and second ion traps are arranged at the start of the ion path;

the method comprising:
(a)(i) storing first ions in the first ion trap, (a)(ii) cooling the first ions in the first ion trap, and then (a)(iii) ejecting the cooled first ions from the first ion trap into the ion path; and
(b)(i) storing second ions in the second ion trap, (b)(ii) cooling the second ions in the second ion trap, and then (b)(iii) ejecting the cooled second ions from the second ion trap into the ion path.

The inventors have recognised that another disadvantage of conventional ion trap-ToF mass analyser arrangements is that they can be relatively slow. This is because the ion trap may require the presence of a collision gas and time to cool the ion packet to a suitable temperature for the analyser. In ion trap-ToF instruments this cooling time is long enough (e.g. ˜1-100 ms) to restrict the operating frequency of the analyser to ˜10-300 Hz, when it might otherwise operate at much higher frequencies (up to 30 kHz depending on the ToF design). In embodiments, by using an array of ion traps in the manner described herein, the operating frequency of the ToF analyser can be significantly increased.

This aspect can, and in embodiments does, include any one or more or each of the optional features described above and elsewhere herein. However, in these aspects and embodiments, the ion traps of the array need not be (and in embodiments are not) operated to confine ions having m/z within different m/z ranges. Thus, the first and second (and optionally further) ion traps may be operated in modes of operation in which the first and second (and optionally further) ion traps confine ions having mass-to-charge ratios (m/z) within the same (or different) m/z range.

Where the trap axis of the first trap is parallel to the trap axis of the second trap (and optionally to the trap axis of each further ion trap) (i.e. in the orthogonal configuration), the method may comprise (b)(i) storing the second ions in the second ion trap at the same time as (a)(ii) cooling the first ions in the first ion trap and/or at the same time as (a)(iii) ejecting the cooled first ions from the first ion trap into the ion path.

The method may comprise (a)(i) storing the first ions in the first ion trap at the same time as (b)(ii) cooling the second ions in the second ion trap and/or at the same time as (b)(iii) ejecting the cooled second ions from the second ion trap into the ion path. The method may comprise repeating steps (a) and (b) one or more times. Thus, the method may comprise repeatedly (e.g. periodically): (i) storing ions in each trap of the array; (ii) cooling the stored ions; and then (ii) ejecting the cooled ions from each trap of the ion path.

The instrument may comprise a third ion trap coupled to the mass analyser, wherein the third ion trap is arranged at the start of the ion path. The method may comprise (c)(i) storing third ions in the third ion trap, (c)(ii) cooling the third ions in the third ion trap, and then (c)(iii) ejecting the cooled third ions from the third ion trap into the ion path. The method may comprise (a)(i) storing the first ions in the first ion trap at the same time as (b)(ii) cooling the second ions in the second ion trap and/or at the same time as (c)(iii) ejecting the cooled third ions from the third ion trap into the ion path. The method may comprise (b)(i) storing the second ions in the second ion trap at the same time as (c)(ii) cooling the third ions in the third ion trap and/or at the same time as (a)(iii) ejecting the cooled first ions from the first ion trap into the ion path. The method may comprise (c)(i) storing the third ions in the third ion trap at the same time as (a)(ii) cooling the first ions in the first ion trap and/or at the same time as (b)(iii) ejecting the cooled second ions from the second ion trap into the ion path. The method may comprise repeating steps (a), (b) and (c) one or more times.

Where the trap axis of the first trap is aligned with the trap axis of the second trap (and optionally with the trap axis of each further ion trap) (i.e. in the parallel configuration), the instrument may comprise an array of trapping regions upstream of the ion trap array, and the method may comprise storing first ions in the first trapping region, and storing second ions in the second trapping region; then transferring the first ions to the first ion trap, and transferring the second ions to the second ion trap; then cooling the first ions in the first ion trap and cooling the second ions in the second ion trap, while at the same time storing further ions in the first and second trapping regions (as described above).

A further aspect provides a non-transitory computer readable storage medium storing computer software code which when executed on a processor performs the method(s) described above.

A further aspect provides a control system for an analytical instrument such as a mass spectrometer, the control system configured to cause the analytical instrument to perform the method(s) described above.

A further aspect provides an analytical instrument, such as a mass spectrometer, comprising the control system described above.

A further aspect provides an analytical instrument, such as a mass spectrometer, comprising:

a mass analyser;

a first ion trap coupled to the mass analyser;

a second ion trap coupled to the mass analyser; and

a control system configured to:

cause the first ion trap to operate in a mode of operation in which the first ion trap confines ions having mass-to-charge ratios (m/z) within a first mass-to-charge ratio (m/z) range, and cause first ions to be stored in the first ion trap;

cause the second ion trap to operate in a mode of operation in which the second ion trap confines ions having mass-to-charge ratios (m/z) within a second different mass-to-charge ratio (m/z) range, and cause second ions to be stored in the second ion trap;

cause the first ions to be ejected from the first ion trap into the mass analyser;

cause the second ions to be ejected from the second ion trap into the mass analyser; and

cause the mass analyser to mass analyse the first ions and the second ions.

A further aspect provides an analytical instrument, such as a mass spectrometer, comprising:

a time-of-flight mass analyser comprising an ion path, and an ion detector arranged at the end of the ion path;

a first ion trap coupled to the mass analyser;

a second ion trap coupled to the mass analyser, wherein the first and second ion traps are arranged at the start of the ion path; and

a control system configured to:
(a)(i) cause first ions to be stored in the first ion trap, (a)(ii) cause the first ions to be cooled in the first ion trap, and then (a)(iii) cause the cooled first ions to be ejected from the first ion trap into the ion path; and
(b)(i) cause second ions to be stored in the second ion trap, (b)(ii) cause the second ions to be cooled in the second ion trap, and then (b)(iii) cause the cooled second ions to be ejected from the second ion trap into the ion path.

These aspects can, and in embodiments do, include any one or more or each of the optional features described above and elsewhere herein.

### BRIEF DESCRIPTION OF THE DRAWINGS

Various embodiments will now be described in more detail with reference to the accompanying Figures, in which:

FIG. 1 shows schematically a mass spectrometer in accordance with embodiments;

FIG. 2A shows schematically two ion traps arranged in a “parallel” configuration in accordance with embodiments.

FIG. 2B shows schematically two ion traps arranged in an “orthogonal” configuration in accordance with embodiments.

FIG. 2C shows schematically two ion traps arranged in a “back-to-back” configuration in accordance with embodiments;

FIG. 3A shows schematically a time-of-flight mass analyser wherein ions are injected into the ion flight path from an ion trap array arranged in a back-to-back configuration, and FIG. 3B shows schematically a time-of-flight mass analyser wherein ions are injected into the ion flight path from an ion trap array arranged in a parallel configuration;

FIG. 4 shows schematically injection optics that may be used to couple an ion trap to a multi-reflection time-of-flight (MR-ToF) mass analyser in accordance with embodiments;

FIG. 5 shows schematically in a multi-reflection time-of-flight (MR-ToF) mass analyser in accordance with embodiments;

FIG. 6A shows a visualisation of detail of injection and correction components of a simulation model of a multi-reflection time-of-flight (MR-ToF) mass analyser configured in accordance with embodiments.

FIG. 6B shows a visualisation of the simulation model of the entire multi-reflection time-of-flight (MR-ToF) mass analyser configured in accordance with embodiments;

FIG. 7 shows simulated traces of ion injections from three of the five extraction traps of the simulation model such that their trajectories merge at the second prism 44;

FIG. 8 is a graph of peak full width half maximum (FWHM) versus trap position;

FIG. 9 shows schematically injection optics that may be used to couple an orthogonal ion trap array to a multi-reflection time-of-flight (MR-ToF) mass analyser in accordance with embodiments;

FIG. 10 shows schematically injection optics that may be used to couple an orthogonal ion trap array to a multi-reflection time-of-flight (MR-ToF) mass analyser in accordance with embodiments;

FIG. 11 shows schematically a switchable branched RF ion guide configured to deliver ions to two different ion traps from a single ion source;

FIG. 12 shows schematically injection optics that may be used to couple a back-to-back ion trap array to a multi-reflection time-of-flight (MR-ToF) mass analyser in accordance with embodiments;

FIG. 13 shows schematically injection optics that may be used to couple a C-trap to an Orbitrap™ mass analyser in accordance with embodiments;

FIG. 14 illustrates schematically injection optics that may be used to couple a back-to-back ion trap array to an Orbitrap™ mass analyser in accordance with embodiments;

FIG. 15 shows a visualisation of a simulation model of a back-to-back ion trap array coupled to an Orbitrap™ mass analyser;

FIG. 16 illustrates schematically injection optics that may be used to couple an orthogonal ion trap array to an Orbitrap™ mass analyser in accordance with embodiments;

FIG. 17 illustrates schematically a parallel ion trap array coupled to an Orbitrap™ mass analyser having two entrance apertures in accordance with embodiments;

FIG. 18 illustrates schematically multiple ion traps coupled to an Orbitrap™ mass analyser having multiple entrance apertures in accordance with embodiments;

FIG. 19 is a graph showing the simulated transmission of different m/z ions through an MR-ToF aperture for ions ejected from a trap operated with RF having a frequency of 4 MHz and an amplitude of 1 or 2 kV peak-peak; and

FIG. 20 is a graph showing calculated ion capacity versus m/z for an extraction trap operated with RF having a frequency 3 and 1.5 MHz RF, and an array comprising both traps.

### DETAILED DESCRIPTION

Time-of-flight (ToF) mass analysers and Orbitrap™ mass analysers require analyte ions to be injected into them. Conventionally, this is done using one of a number of different techniques, including for example, orthogonal extraction, laser desorption, or extraction from a single RF ion trap. This latter method is used in commercial Orbitrap™ mass analysers from Thermo Fisher Scientific and in some commercial ToF mass analysers. Typically, a quadrupole ion trap is used to generate a well-defined ion packet with minimised spatial and energy spreads.

U.S. Pat. No. 7,425,699 describes an analytical instrument comprising an ion trap and an Orbitrap™ mass analyser. Most of the configurations described in this disclosure work as modifications to Orbitrap™ mass analysers or to multi-reflection time-of-flight mass analysers of the type described in US Patent Application No. 2015/0028197, although there is general compatibility with other types of ToF analyser such as reflectron ToF mass analysers.

The inventors have now recognised that ion traps suffer two key disadvantages when used as ion sources for mass analysers. Firstly, they require the presence of collision gas within the ion trap, and time is needed to cool the ion packet to a suitable temperature for the analyser. In ion trap-ToF instruments, this cooling time is long enough (1-100 ms) to restrict the operating frequency of the analyser to 10-300 Hz, where it might otherwise operate at much higher frequencies (up to 30 KHz depending on the ToF scheme) (the time of-flight of ions through a ToF analyser is typically below 100 μs, while the time for ion packet preparation in a trap may reach several milliseconds). Thus, gas-filled ion traps typically cool ion packets much more slowly than a ToF analyser can operate, causing inefficient usage of the analyser. (In Orbitrap™ mass analysers by contrast, the Orbitrap™ mass analyser is typically the slowest component. In this regard, U.S. Pat. No. 8,692,189 proposes a single ion trap coupled to an array of multiple Orbitrap™ mass analysers.)

The second disadvantage arises because the ability of an ion trap to trap and store ions is highly dependent on the mass to charge ratios (m/z) of the ions. The trapping pseudopotential well depth falls with increasing m/z, causing an increase in the radius of the ion cloud until the ion confinement is not possible at all, and ions of too low m/z cannot be trapped at all because of the low-mass cut-off effect (see, e.g., R. March, J. Mass. Spec., 1997, 32, 351-369). Overly large ion clouds impede transmission into the analyser, as well as create larger ion energy distributions when ions are extracted from the trap by application of an extracting DC gradient, which can further reduce transmission and resolution of the analyser. The m/z range over which an ion trap performs acceptably can be increased by increasing the RF frequency and/or voltage, but practical limitations are already largely reached with RF traps capable of operating with, e.g., several kilovolts of 3 MHz RF. Thus, extraction ion traps in general have a limited m/z range over which they can trap ions and form a suitably compressed ion cloud.

Arraying mass analysers, as in U.S. Pat. No. 8,692,189, with each analyser tuned to a different m/z range, would allow an enhancement of the overall m/z range, but at the substantial cost of analyser duplication, which may be impractical for a commercial instrument.

Described herein are methods to couple more than one extraction trap to a single mass analyser (such as a ToF mass analyser, e.g. multi-reflecting ToF (MR-ToF) analyser, or an Orbitrap™ mass analyser), with minimal compromises to the analyser's performance. The individual traps of an array of traps may either be operated in succession, thereby multiplying the operation frequency of the instrument, and/or operated with different m/z range parameters, so that the overall m/z range analysed in one duty cycle is extended.

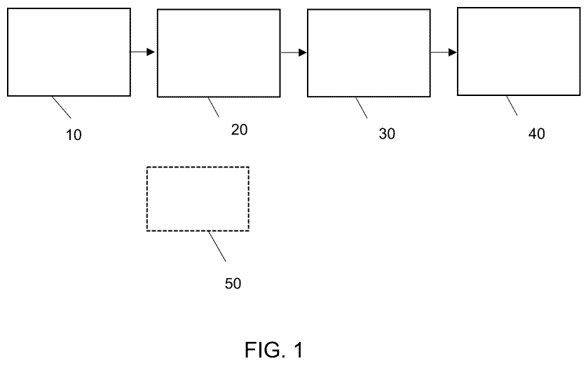

FIG. 1 illustrates schematically an analytical instrument, such as a mass spectrometer, configured in accordance with embodiments. As shown in FIG. 1, the analytical instrument includes an ion source 10, one or more ion transfer stages 20, and an array of extraction ion traps 30 coupled to a mass analyser 40.

The ion source 10 is configured to generate ions from a sample. The ion source 10 can be any suitable continuous or pulsed ion source, such as an electrospray ionisation (ESI) ion source, a MALDI ion source, and atmospheric pressure ionisation (API) ion source, a plasma ion source, an electron ionisation ion source, a chemical ionisation ion source, and so on. More than one ion source may be provided and used. The ions may be any suitable type of ions to be analysed, e.g. small and large organic molecules, biomolecules, DNA, RNA, proteins, peptides, fragments thereof and the like.

The ion source 10 may optionally be coupled to a separation device such as a liquid chromatography separation device or a capillary electrophoresis separation device (not shown), such that the sample which is ionised in the ion source 10 comes from the separation device.

The ion transfer stage(s) 20 are arranged downstream of the ion source 10 and may include an atmospheric pressure interface and one or more ion guides, lenses and/or other ion optical devices configured such that some or all of the ions generated by the ion source 10 can be transferred from the ion source 10 to the ion trap array 30. The ion transfer stage(s) 20 may include any suitable number and configuration of ion optical devices, for example optionally including any one or more of: one or more RF and/or multipole ion guides, one or more ion guides for cooling ions, one or more mass selective ion guides, and so on.

The extraction trap array 30 comprises plural extraction ion traps arranged downstream of the ion transfer stage(s) 20, with each extraction trap being configured to receive and accumulate ions from the ion source 10 (via the one or more ion transfer stages 20). The extraction trap array 30 can include any (plural) number of extraction traps, such as two, three, four, five or more extraction traps. Each extraction trap in the array 30 can comprise any suitable extraction trap, such as a quadrupole ion trap. One or more or each extraction trap may be elongated in an axial direction (thereby defining a trap axis) in which the ions enter the trap. Ions may be trapped radially in the trap by applying RF voltage(s) to trapping (e.g. rod) electrodes of the trap. One or more or each extraction trap may be a linear ion trap or a curved linear ion trap (C-trap), i.e. where the trapping rod electrodes are curved.

Ions from the ion source 10 can be accumulated in each extraction trap, e.g. for a desired fill time. Thus, the instrument may be configured such that ions can be accumulated in each trap of the extraction trap array 30 with an adjustable accumulation time (fill time). By controlling the fill time of ions into each trap (where the flux of ions into the trap is known or can be approximated), the total number of ions accumulated in each extraction trap can be controlled.

Once accumulated and cooled in an extraction trap of the array 30, ions within the trap can be ejected directly into the mass analyser 40. Ions may be ejected from an extraction trap in an axial direction, or the ions may be ejected from a trap in a direction orthogonal to the axis of the trap (orthogonal ejection), for example by applying one or more suitable DC voltages (e.g. push and pull voltages) to the electrodes of the trap. Thus, each extraction trap may receive a continuous beam of ions and pulse out cooled ion packets with spatial and energy properties that are matched to the mass analyser.

The mass analyser 40 is arranged downstream of the array of ion traps 30, and may be configured to receive ions ejected from each extraction trap of the array 30. The mass analyser is configured to analyse the received ions so as to determine their mass to charge ratio and/or mass, i.e. to produce a mass spectrum of the ions. The mass analyser 40 may be an ion trap mass analyser, such as an electrostatic orbital trap, and more specifically an Orbitrap™ FT mass analyser as made by Thermo Fisher Scientific. Alternatively, the mass analyser 40 may be a time-of-flight (ToF) mass analyser, such as a linear ToF analyser, a reflectron ToF analyser, or a multi-reflecting time-of-flight (MR-ToF) mass analyser.

It should be noted that FIG. 1 is merely schematic, and that the instrument can, and in embodiments does, include any number of one or more additional components. For example, in particular embodiments, the mass spectrometer includes a collision or reaction cell.

As also shown in FIG. 1, the instrument is under the control of a control unit 50, such as an appropriately programmed computer, which controls the operation of various components of the instrument. The control unit 50 may also receive and process data from various components including the analyser 40. The control unit 50 is configured, amongst other things, to determine the settings (e.g. ion trap 30 fill time(s), etc.) for the injection of ions into the mass analyser 40 for analytical scans.

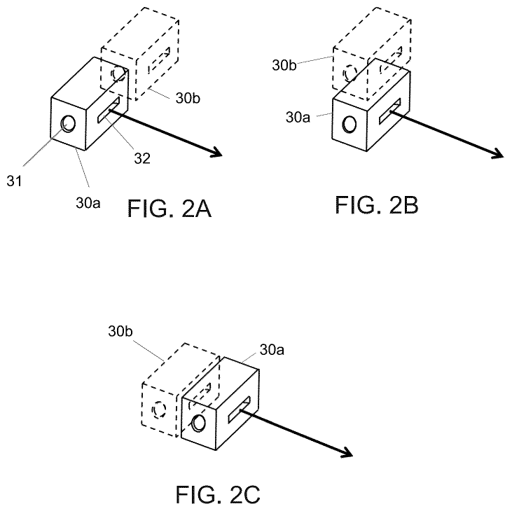

FIG. 2 shows schematically various possible configurations of the extraction trap array 30. As illustrated by FIG. 2, each extraction trap array comprises at least a first extraction trap 30a and a second extraction trap 30b. Each extraction trap array could also include one or more additional extraction traps (not shown).

As described above, each extraction trap 30a, 30b may be a linear ion trap such as a quadrupole ion trap. Thus, as shown in FIG. 2, each trap 30a, 30b may be elongated in an axial direction (thereby defining a trap axis). Ions can enter the trap in the axial direction via an entry/exit aperture 31 arranged at one end (along the longitudinal axis) of the ion trap. Similarly, ions may be ejected from each ion trap via an entry/exit aperture 31. Each ion trap may comprise one or two such entry/exit apertures 31 arranged at one or both ends of the ion trap.

Ions accumulated within the trap can be ejected into the mass analyser 40 in a direction orthogonal to the trap axis (in the direction indicated by the arrows in FIG. 2) via an extraction aperture 32. The extraction aperture 32 may be arranged on one side of the trap, parallel to the trap axis. Where the extraction trap is a quadrupole trap, the extraction aperture 32 may comprise, e.g., a slot cut into one rod of the quadrupole's four parallel rod electrodes.

There are three dimensions in which linear extraction traps can in principle be arrayed, as illustrated in FIG. 2. FIG. 2A shows a “parallel array” where trapping regions are aligned side to side; this has the advantage of allowing both traps to be filled from a single ion guide. FIG. 2B shows an “orthogonal array”, where the trapping regions are stacked out of the plane formed by the length and direction of the extracted ion cloud. FIG. 2C shows a “back-to-back array” where the extracted ion cloud from one trap must fly through another trap to reach the analyser 40. These various arrangements can be combined so that e.g. extraction traps may be arrayed diagonally. The various advantages and disadvantages of each of these stacking methods are examined further below.

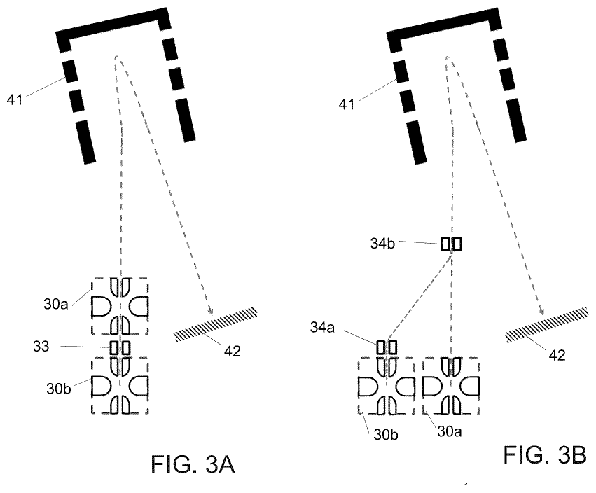

FIG. 3 illustrates schematically how an extraction trap array 30 may be coupled to a regular time-of-flight analyser incorporating a reflectron. FIG. 3A shows a back-to-back array configuration, and FIG. 3B shows a parallel array configuration.

As shown in FIG. 3, the ToF analyser comprises a single ion mirror or reflectron 41, and a detector 42 arranged at the end of an ion path. Ions may be ejected from each extraction trap 30a, 30b of the array into the ion path, whereupon the ions travel to the detector via the reflectron 41. The m/z spectrum of the ions is determined by determining their arrival times at the detector 42 (i.e., the time taken for ions to travel from an extraction trap 30a, 30b and to arrive at the detector 42 via the ion path).

As shown in FIG. 3A, in the back-to-back array configuration, the ion beam from the second trap 30b project through the first trap 30a. An additional lens 33 may be provided between the traps 30a, 30b to match beam divergence between the two traps' extracted ions.

As shown in FIG. 3B, the parallel array configuration may include two deflectors 34a, 34b, which may be used to merge the ion trajectories emanating from the two traps 30a, 30b. It should be noted that in this arrangement, the illustrated parallel array is functionally identical to the orthogonal array described above.

Various embodiments described below are directed particularly to multi-reflectron ToF analysers and to Orbitrap™ mass analysers. However, it will be understood that the various configurations described herein have more general applicability to various other designs of time-of-flight and electrostatic analysers.

### 1. Application to MR-ToF Analyser

An MR-ToF mass analyser, such as the MR-ToF mass analyser described in U.S. Pat. No. 9,136,101, is formed from two opposing ion mirrors elongated generally in a drift direction. Ions may be extracted from an ion trap into the mirror system via a set of injection optics, which typically comprises one or more lenses to control beam expansion and one or more deflectors to align the ion packet to the analyser. In the MR-ToF of U.S. Pat. No. 9,136,101, ions oscillate between the two mirrors as they move in the drift direction, and experience a retarding potential generated by a combination of the mirror inclination and a shaped correction electrode. Upon reaching the turning point, the ions follow a return drift path down the mirror set to a detector.

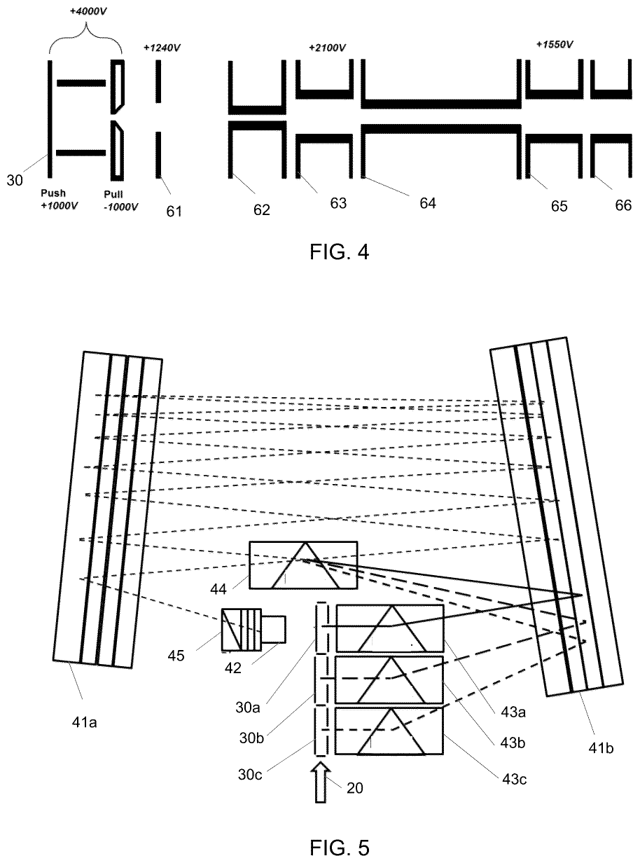

FIG. 4 shows an example of injection optics suitable for a single (e.g. 2 mm r₀) extraction trap MR-ToF. The illustrated injection optics may be arranged along the ion path between the extraction trap 30 and the ion mirror first encountered by the ions. As shown in FIG. 4, the linear ion trap 30 (which may be operated at a voltage of around 4 kV) is followed by a first lens 61 (which may be operated at a voltage of around 1.24 kV), a grounded electrode 62, and a second lens 63 (which may be operated at a voltage of around 2.1 kV). Next, a deflector such as a prism deflector (which may be operated at a voltage of around 250 V) is provided within a 0V flight region 64. This is followed by a third lens 65 (which may be operated at a voltage of around 1.55 kV) and another grounded electrode 66. As also shown in FIG. 4, push/pull DC voltages of around ±1 kV may be applied to electrodes of the extraction 30 to eject ions from the extraction trap 30 and into the injection optics.

Various embodiments in which an array of multiple extraction traps is coupled to an MR-ToF mass analyser will now be described.

### 1.1 Parallel Trap Array

In accordance with a first set of embodiments, a series of trapping regions are linked side-by-side, i.e. in a parallel array configuration. This allows all of the traps to be fed by the same ion guide in series. The first trap acts a conductor for the ions to be stored in the last trap. Injection optics such as those depicted in FIG. 4 can be duplicated for each trap in the trap array, so that each trap injects ions into a separate deflector (which may be a 45-degree prism-like structure to accept the elongated ion cloud). The required lenses of the optics can be either separate or extended so that each lens covers all injection regions.

FIG. 5 shows schematically one such arrangement of an MR-ToF analyser with a parallel extraction trap array, where the injection optics are duplicated for each trap in the array (the lenses of the injection optics are not shown in FIG. 5). In the embodiment depicted in FIG. 5, the array 30 includes three extraction traps 30a, 30b, 30c, but the array could include fewer (i.e. two) or more than three traps.

As shown in FIG. 5, the MR-ToF analyser 40 includes a pair of ion mirrors 41a, 41b that are spaced apart and face each other in a first direction. The ion mirrors 41a, 41b are elongated generally along an orthogonal drift direction between a first end and a second end.

The extraction trap array 30 is arranged at one end (the first end) of the analyser 40. The extraction trap array 30 is arranged and configured to receive ions from the ion transfer stage(s) 20. Ions may be accumulated in each extraction trap 30a, 30b, 30c of the array, before being injected into the space between the ion mirrors 41a, 41b. Ions may be injected from each trap 30a, 30b, 30c with a relatively small injection angle or drift direction velocity, creating a zig-zag ion trajectory.

Injection optics 43a, 43b, 43c comprising one or more lenses and/or one or more deflectors may be arranged along the ion path, between each extraction trap and the ion mirror 41b first encountered by the ions. In general, each set of injection optics 43a, 43b, 43c may be configured to suitably condition, focus and/or deflect the ion beam, i.e. such that it is caused to adopt the desired trajectory through the analyser 40.

The analyser 40 includes a second deflector (e.g. prism) 44, which is arranged along the ion path between the ion mirrors 41a, 41b, e.g. approximately equidistant between the ion mirrors 41a, 41b, along the ion path after its first ion mirror reflection (in ion mirror 41b), and before its second ion mirror reflection (in the other ion mirror 41a).

The analyser 40 also includes a detector 42 which may optionally be preceded by a plane corrector 45. In operation, ions are injected from each ion trap 30a, 30b, 30c into the space between the ion mirrors 41a, 41b, in such a way that the ions adopt a zigzag ion path having plural reflections between the ion mirrors 41a, 41b, whilst: (a) drifting along the drift direction from the deflector 44 towards the opposite (second) end of the ion mirrors 41a, 41b, (b) reversing drift direction velocity in proximity with the second end of the ion mirrors 41a, 41b, and then (c) drifting back along the drift direction to the deflector 44. The ions can then be caused to travel from the second deflector 44 to the detector 42 for detection.

The different injection deflectors 43a, 43b, 43c can be used to give the ions from each trap 30a, 30b, 30c a different injection angle, so that they enter the second deflector 44 at the same position. Additionally or alternatively, this may be accomplished with differing tilts on the three traps 30a, 30b, 30c, but this may break the straight path between the traps 30a, 30b, 30c and so may impede filling of the traps.

Ions may be extracted from each trap 30a, 30b, 30c in succession so that ions from each trap 30a, 30b, 30c reach the second deflector (prism) 44 at different times. Application of a different voltage to the deflector 44 for the injection of ions from each trap 30a, 30b, 30c allows the trajectories to be merged (as long as ions from different traps do not arrive at the same time). Extraction of all the returning ions from the deflector 44 to the detector 42 will require only one voltage.

A complicating factor here is that although the point of the time focus is preserved for arrayed traps, the focal plane is not shared due to the different deflections the ion packets have received. Therefore, a switchable plane corrector 45 may be used at the end of the ion path to match the ion packets to the detector plane. The plane corrector 45 may be simply a deflector, such as a prism deflector to accept the wide spatial spread of the ion beam without adding time aberrations, although dipole fields generated from other devices are also suitable.

As mentioned above, the extraction trap array 30 may be used to increase one or both of the m/z range and the scan frequency of the analyser 40.

### 1.1.1 Scan Frequency

For scan frequency enhancement, the traps 30a, 30b, 30c may be identically sized and may have the same applied RF and DC voltages, thereby simplifying construction and operation of the array. The traps 30a, 30b, 30c should be sufficiently spaced apart that the extraction potential from one does not affect another.

A difficulty with this arrangement is that ions cannot be admitted to the first trap 30a, for example, when ions are already being cooled and stored in the third trap 30c. Therefore the traps 30a, 30b, 30c may be filled in sequence, then ions cooled, and then ejected in quick succession. This creates a mismatch, in that all of the traps 30a, 30b, 30c are inaccessible during the relatively long cooling and ejection period. This in turn limits the dynamic range as the source ion beam cannot be efficiently distributed between the three traps 30a, 30b, 30c. To address this, the extraction trap array 30 may be preceded by another three trapping regions, which may be filled up with ions whilst the extraction traps 30a, 30b, 30c are occupied. It will be appreciated that the other array configurations, which require multiple injection channels, do not suffer from this problem.

### 1.1.2 Mass Range

For enhancement of m/z range, the ion traps 30a, 30b, 30c may have the same applied RF frequency (and preferably similar phase), but the applied RF amplitude may be varied between the different traps. This allows relatively straightforward design of suitable structures and electronics. This may also allow the traps to be apertureless, such that ions can flow between the traps with a minimum of energy, thereby reducing the necessary cooling time.

Ion may be admitted to the traps 30a, 30b, 30c sequentially, and the trap voltages may be varied for the ions travelling through or into them at any point in time. For example, when admitting high m/z ions to the first trap 30a, the second trap 30b and the third trap 30c may be operated with a high voltage to maximise transmission, and then may be switched to lower voltages for low m/z trapping.

It may, however, be preferable that the different traps 30a, 30b, 30c all use relatively high voltages to allow deep trapping potentials, but that the RF frequency is varied between the traps to obtain different m/z trapping ranges. This creates complexity for parallel array configurations (but not for the other array configurations), as ions have to be transferred across traps with different RF frequencies. This may be addressed by using frequency varying power supplies, such as digital RF, in a similar manner to that described above.

In these embodiments, extraction of ions from all of the traps 30a, 30b, 30c may occur in the same analyser scan, but should only be simultaneous if the m/z range of trapped ions in each trap is non-overlapping. For example, the system could fail if two traps released m/z=195 ions at the same time, as these ions would arrive at the second prism 44 at roughly the same time and the second prism 44 could only be set to a voltage to properly accept one set of ions. Most likely the “wrong” ion packet would simply be lost, although it is possible that some ions could reach the detector 42 with an aberrant time-of-flight.

To address this, where the m/z ranges of two or more traps overlap, a suitable delay time may be implemented between extractions from each trap. The ions may be released from each trap in order of the lowest m/z trap to the highest m/z trap, with a delay time equivalent to the time-of-flight to prism 44 of the overlapping m/z range. However, the scans may still need to be separated if low m/z ions can return to the deflector 44 within the delay period, such that a different deflector 44 voltage is required.

Because in these embodiments the ion traps 30a, 30b, 30c have different trapping properties, low-mass-cut-offs etc., it is likely that when equivalent ion packets are injected into each trap then ions will be lost, so that some sensitivity will be lost. It is therefore preferable that the ions are separated into m/z range groups before being transferred to the extraction traps 30a, 30b, 30c. This may be accomplished by arranging the extraction traps 30a, 30b, 30c downstream from another linear ion trap capable of m/z selective, preferably axial, ion ejection. A mass scan from the linear ion trap (with only low resolution required) may eject a suitable m/z range for each trap, without wasting ions. This ion trap should have an ion capacity at least equivalent to the sum of the extraction traps, and the speed of the scan should be fast enough not to impede the analyser operation (e.g. <5 ms).

In embodiments, each trap 30a, 30b, 30c should have an independent m/z calibration.

### 1.1.3 Parallel Trap Array Simulation Data

A simulation model was built with five independent extraction traps with centres 20 mm (or more) apart, each with its own injection lenses and a 45-degree deflector prism. For non-simultaneous extraction from the traps, sufficient space (>20 mm) was placed between extraction regions to protect trapped ions from the extraction field of an adjacent trap. A plane corrector coupled to the detector was simulated as a 20-degree deflector prism.

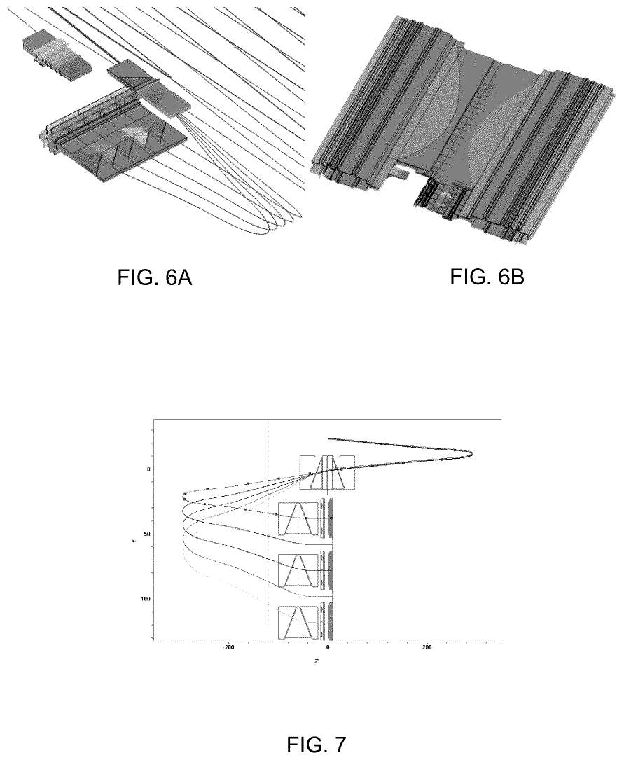

This simulation model is visualised in FIGS. 6A-6B, shown with (FIG. 6B) and without (FIG. 6A) the ToF analyser mirrors and stripe electrodes.

Table 1 shows simulated optimum voltages to be applied to the various components of the system for various different trap spacings (“offset”), as well as the effects on the time-of-flight (ΔToF) and full-width-half-maximum (FWHM).

TABLE 1

| | | Prism 44 | | | |
|---|---|---|---|---|---|
| Offset | Prism 43 | Voltage at | Corrector 45 | ΔToF | FWHM |
| (mm) | Voltage (V) | Injection (V) | Voltage (V) | (ns) | (ns) |
| 0 | 250 | −125 | −3000 | 0 | 1.4 |
| 20 | 392 | −265 | −3000 | 0 | 1.5 |
| 40 | 525 | −405 | −2250 | 11 | 1.4 |
| 60 | 668 | −545 | −1200 | 32 | 1.8 |
| 80 | 820 | −685 | 0 | 66 | 3 |

FIG. 7 shows simulated merging of the ion trajectories from a parallel trap array 30 at the second prism 44 in the appropriate manner as described above.

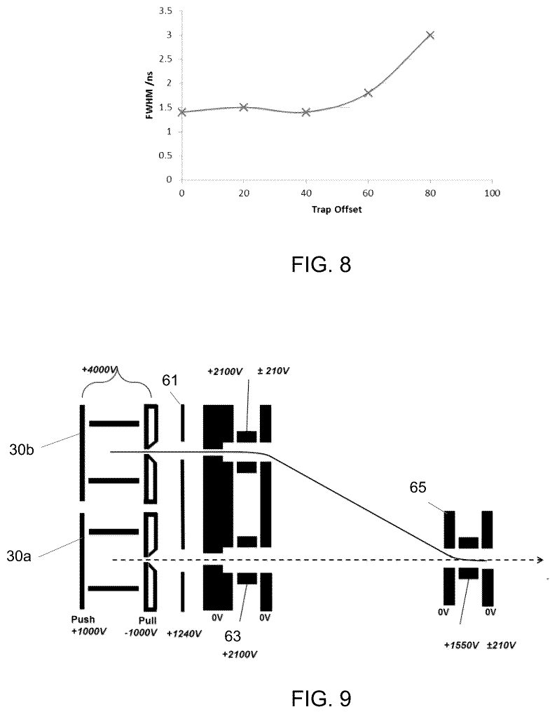

FIG. 8 illustrates the effect of trap position offset on the analyser full-width-half-maximum (FWHM). As shown in FIG. 8, the FWHM increases significantly when a trap in the array is 60 mm or more from the centre of the first trap. This limits the number of traps in the parallel array to be not more than four, to preserve good resolution across all traps.

### 1.2 Orthogonal Array

A further set of embodiments involves the stacking of additional traps above and/or below a central trap, i.e. in an orthogonal array configuration.

In these embodiments, the centre of trapping regions should be separated by 2*r₀ plus allowances for electrode thickness and minimisation of capacitive coupling where necessary. For a 2 mm trap, this would be a minimum of 5 mm or more realistically 7 mm. This provides a much smaller distance over which ion trajectories must be realigned, when compared with the 20 mm separation of the parallel array trapping regions described above. This may be accomplished before ions reach the first mirror 41b (thereby providing improved reflection) by using a pair of deflectors. This pair of deflectors may be implemented, for example, by separating the top and bottom halves of the second 63 and third 65 injection lenses.

FIG. 9 shows schematically suitable injection optics, which are an adaptation to the injection optics shown in FIG. 4. As illustrated by FIG. 9, ions ejected from a first trap 30a are injected normally, but ions from a second trap 30b are deflected down by a dipole field added to the second lens 63, and then enter the third lens 65, where a switchable dipole field realigns the ion trajectory to the central plane of the analyser.

In these embodiments, a prism deflector as in FIG. 4 could obstruct the beam, and thus may be removed. The injection angle of ions into the analyser 40 should thus be determined solely by the fixed angle of the ion trap, although a much wider analyser with more space between the mirrors could potentially make room for a deflector.

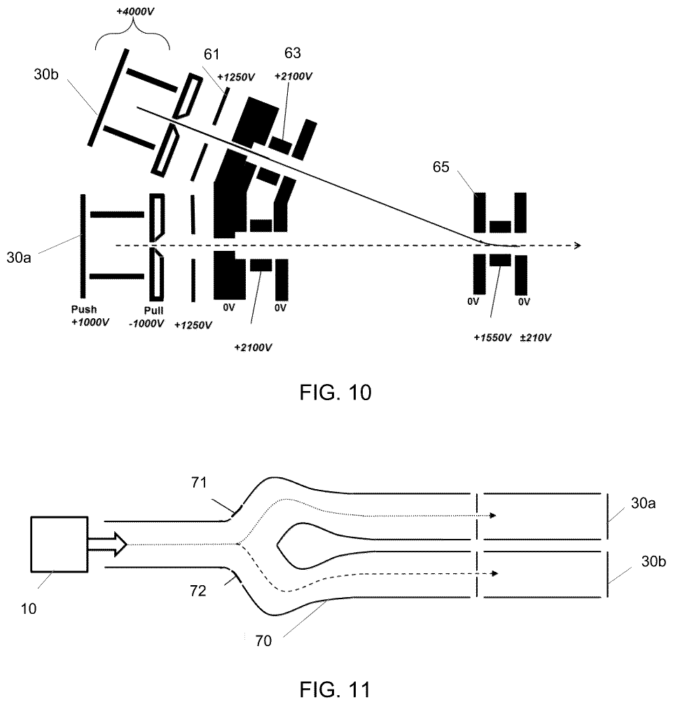

FIG. 10 shows a variation of this structure, where instead of a deflector in the second lens 63, the stacked trap 30b is tilted downwards. However, as well as providing an average ion velocity towards the central plane of the analyser 40, this method also increases the ion energy spread out of the analyser plane (as the extraction field is no longer parallel to the analyser), and reduces performance relative to the arrangement of FIG. 9.

In these embodiments, it is beneficial for resolution to have a plane corrector 45 mounted in front of the detector 42, similar to that described for the parallel trap arrangements. However, as this must adjust a much narrower tilt, the plane corrector may be implemented simply as two plates protected by ground, rather than a shaped prism.

A simulation model was constructed with out-of-plane arrayed extraction traps coupled to an MR-ToF analyser as described above. The second injection deflector (prism 44 in FIG. 5) was not used as the traps were angled instead, and the detector plane was tilted to match the tilt of the trap. In the simulation, the same structure as the third lens 65 was used, with 0, ±200 or ±400V applied depending on trap offset (of 0, 7 or 14 mm). Simulation results for the three trap offsets with ions of m/z=195 are shown in Table 2.

TABLE 2

| Trap Offset | Plane | Deflector | FWHM |
|---|---|---|---|
| (mm) | Correction | 65 (V) | (ns) |
| 0 | N/A | 0 | 1.0 |
| 7 | Corrected | 210 | 1.9 |
| 14 | Corrected | 420 | 4.6 |
| 7 | Uncorrected | 210 | 3.6 |

Despite having similar initial ion conditions to the MR-ToF simulation shown in Table 1, the reduced aberration of ions from the offset=0 trap leave it with a small full-width-at-half-maximum (FWHM) of 1 ns, which increases markedly to 1.9 ns with the second trap at +7 mm. This is still within the realm of acceptability for performance. In contrast, the results for the 14 mm displaced trap and the 7 mm trap without a plane correcting deflector applied at the detector are much weaker. Thus, it is reasonable to have an array of three stacked traps, e.g. with offsets of −7 mm, 0, and +7 mm. However, a fourth or fifth trap could ruin performance beyond acceptability. Of course, two traps, e.g. with offsets of ±3.5 mm, would also be suitable.

In these embodiments, ions may be delivered to the multiple traps 30a, 30b from a single ion source 10 (unless e.g. multiple adjacent sources are used together in a multiplexed experiment, as described in U.S. Pat. No. 7,217,919). A suitable method to do this is to use a branched multipole ion guide, e.g. as described in U.S. Pat. No. 7,829,850.

FIG. 11 shows such an arrangement schematically, where a branched RF ion guide 70 includes additional curvature of the ion guide after the split, in order to align the branches with the ion traps 30a, 30b. First 71 and second 72 gate electrodes are provided at the entrance to the ion guide branches, to allow a single ion source 10 to feed both traps 30a, 30b in a switchable manner.

In these embodiments, as for the parallel ion trap array embodiments, for mass range extension applications, it is beneficial if the split ion guide 70 is preceded by an additional ion trap. The additional ion trap may be operated to send the correct m/z ranges into each trap, thus enhancing transmission and/or allowing both traps to be used in the same ToF cycle.

Other techniques could be used to replace the additional ion trap and branched multipole, such as an ion beam flux pre-separator, or more conventional electrostatic methods at low vacuum with switched deflectors. However, these latter methods may require relatively high ion energies and could result in increased ion losses and fragmentation.

### 1.3 Back-to-Back Array

A further set of embodiments involves lining up the extraction traps along the axis of extracted ions, so that ions extracted from one trap fly through another before entering injection optics 43 and the analyser 40, i.e. a back-to-back array configuration. This allows the traps to share common injection optics, minimises gas load into the analyser 40, and maintains the ion packets at a common injection angle and plane.

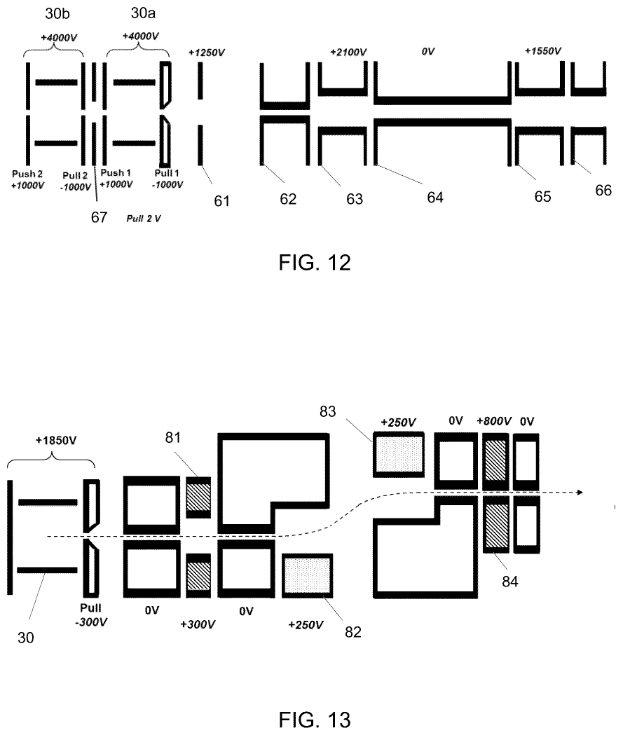

An example of such a configuration is illustrated in FIG. 12, with back-to-back traps 30a, 30b separated by a thin lens plate 67, which can serve to limit capacitive coupling between the two traps 30a, 30b and/or can have an additional voltage applied (e.g. around −750V relative to the 4 kV trap floating voltage), to help control the expansion of ions from the second trap 30b. Although two aligned traps 30a, 30b are shown, more than two traps could be provided. The injection optics 43 may be identical to those shown in FIG. 4.

In these embodiments, the array 30 may be operated by, after extraction of ions from the first trap 30a in the normal manner, switching of the first trap 30a push electrode to a pull voltage, in order to apply push/pull voltages to the second trap 30b. This allows passage of ions from the second trap 30b through the first trap 30a, and requires a three-way electronic switch on the first trap's 30a push electrode.

Unfortunately, this array configuration is less suitable for MR-ToF analysers. This is because the minimum distance between the two traps 30a, 30b makes it challenging to match the ion time foci from both traps 30a, 30b, even when utilising tricks such as different push/pull voltages, or applying different floating voltages to regions of the injection optics 43 for ions from the first 30a and second 30b traps. In simulations, with the MR-ToF mirrors set to a compromise value between the optima for the two traps 30a, 30b, the FWHM doubled to >3 ns, which may be unacceptable.

Nevertheless, this array configuration may be better suited to ToF analysers with a longer flight length before the first reflection, such as e.g. single reflection ToF analysers.

In these embodiments, a more minor issue is that when ions from one trap fly through another, the flight path through a relatively high-pressure region is potentially more than tripled. For ions of mass>1 kDa, scattering is already a problem at a standard pressure of around 5×10⁻³ mbar. Lower pressure traps may, however, make this less of a problem.

### 2. Application to Orbitrap™ Analyser

The design of arrayed extraction traps suitable for Orbitrap™ mass analysers is relatively more straightforward, as there is no requirement to maintain identical ion time foci. There is, however, a greater need to maintain tight control of the spatial dispersion.

The Orbitrap™ analyser itself also has a m/z range limited by the rise time of its central electrode voltage, and can admit ions for a limited time period of approximately 8 μs. This provides a motivation to limit the length of the injection optics (e.g. <100 mm), so as to limit the ion arrival time-of-flight spread across a given mass range. This is significant for high-m/z ranges, as absolute time spreads are large. For example, ions with m/z=500 take only 4 μs to reach the Orbitrap™ analyser, but ions with m/z=6000 will take more than 15 μs and may fail to be admitted. In these embodiments, array configurations that require a delay between extractions may increase the arrival time spread, and thereby impose limitations to the overall m/z range.

Another notable issue related to the Orbitrap™ analyser's central electrode voltage is that the arrival time of ions into the Orbitrap™ analyser affects their energy within the trap, and has a small ppm level effect on oscillation frequency. For extraction trap arrays, this means that the calibration will be slightly different for each trap, and that if mass ranges overlap there may even be peak splitting.

FIG. 13 shows schematically commercial Orbitrap™ analyser injection optics, as described in U.S. Pat. No. 7,425,699. Ions are ejected from a C-Trap 30 (which may be operated at a voltage of around 1.85 kV), with a curved pull electrode (not shown) to help focus ions in the out-of-plane dimension. The ions pass through pumping regions, though a first lens 81 (which may be operated at a voltage of around 300 V), are deflected up by a pairs of deflectors 82, 83 (which may each be operated at a voltage of around 250 V) to improve differential pumping, before reaching a second lens 84 (which may be operated at a voltage of around 800 V) and passing onwards to the Orbitrap™ analyser (not shown). The arrayed trap configurations described herein attempt to maintain this pathway as much as possible.

### 2.1 Back-to-Back Array

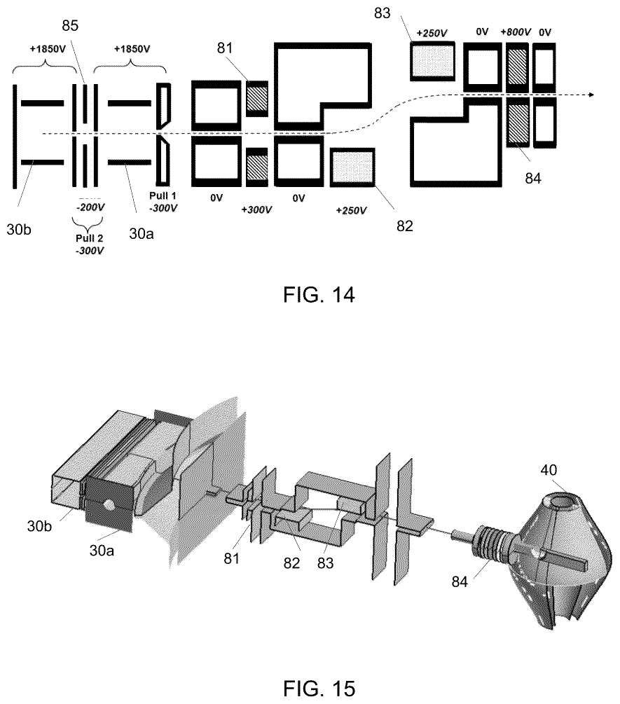

A first set of embodiments comprises a back-to-back extraction trap array coupled to an Orbitrap™ mass analyser. FIG. 14 illustrates schematically injection optics suitable for coupling a back-to-back trap array to an Orbitrap™ mass analyser.

As shown in FIG. 14, as an almost identical modification to the back-to-back array MR-ToF analyser, a second trap 30b is added to the C-trap 30a, with a separating lens electrode 85 provided between to allow control of the second extracted ion cloud. This has the advantage of leaving the injection optics untouched.

In operation, the pull voltage may be firstly applied to the C-Trap pull electrode, ejecting its ions, and after a short delay to clear the C-Trap 30a (e.g., ˜1 μs), the pull voltage is then also applied to the back electrode of the C-Trap 30a and the pull electrode of the second trap 30b (optionally also to the lens, although this may be maintained at a static potential). This extraction method minimises the considerable differences in the treatment of the two ion packets, but simplifies the application of pulsed voltages. Ions from the first trap 30a and the second trap 30b see similar extraction fields, and most of the out-of-plane focusing is carried out by the field between the curved C-Trap pull electrode and the first grounded region of the injection optics. Thus, the second trap may be rectilinear (i.e. an R-Trap), though it may be better to have some curvature (i.e. a C-Trap).

A simulation model with two back-to-back 3 mm r₀ traps 30a, 30b coupled to an Orbitrap™ analyser 40 is shown in FIG. 15. This method of extraction shows some loss of transmission to the Orbitrap™ analyser entrance slit for the second trap 30b (63% versus 85% for the C-trap 30b). This is largely an issue of spatial dispersion and can be improved to 73% by increasing the lens 81 voltage in advance of the deflection region by around 200V, with no negative loss of transmission from the C-Trap 30a. It may be possible to equalise performance by utilising better tuning.

As with the MR-ToF embodiments, it is preferable not to have overlapping m/z ranges between the two traps 30a, 30b, although in principle this should not be as significant an issue here (depending on the magnitude of the difference in arrival time to the Orbitrap™ analyser 40, which should be similar). In some regards, it is best to store high m/z ions in the C-Trap 30a and low m/z ions in the R-Trap 30b, such that low masses are ejected later but catch up to the high masses in the injection optics, thereby reducing the ion arrival time spread at the Orbitrap™ analyser 40. Also this reduces ion scattering caused by time spent by high masses in high pressure regions, which is a limitation of the back-to-back array configuration.

In these embodiments, because of scattering and expansion of the ion beam, it is unlikely that more than two or three traps in sequence will be viable.

### 2.2 Orthogonal Array

A further set of embodiments comprises an orthogonal extraction trap array coupled to an Orbitrap™ mass analyser. Because the standard Orbitrap™ analyser injection optics (of FIG. 13) already utilise a relatively large deflection (about 3 mm) to separate the ion beam from the stream of gas released from the ion trap 30, it is relatively convenient to add a second trap 30b (but no more) by mirroring the deflection of the first trap 30a.

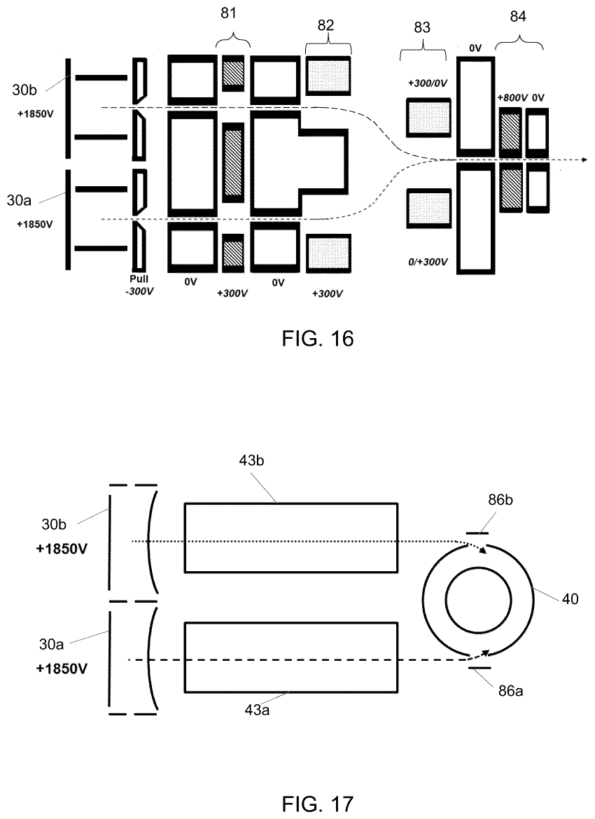

An embodiment of this configuration is illustrated schematically by FIG. 16. As shown in FIG. 16, the C-Trap 30a, 30b, first lens 81 and first deflector 82 are mirrored, and the second deflector 83 and what was formerly its accompanying ground region are made switchable (e.g. between around 300 V and 0V) to accept ions from both traps 30a, 30b at different times. The remaining ion optics are unchanged.

In these embodiments, as the ion beam will need to be shifted by around 4 mm (versus the usual 3 mm), the deflection voltage may be stronger or the deflector region may be extended.

In these embodiments, due to the symmetry, transmission and related ion properties from each trap 30a, 30b should be approximately identical, with the exception of ion arrival time.

In these embodiments, it is again preferable that clearly differentiated m/z ions are stored in the different traps 30a, 30b, although this is not essential. There may be a delay in extraction between the two traps 30a, 30b, which may be long enough so that ions from the first trap 30a have left the deflector region 83 before it switches voltage to accept ions from the second trap 30b. This delay (e.g. around 0.5-2 μs), which may be equivalent to the time the highest m/z ions from the first extraction take to cross the deflector 83, is entirely dependent on the two trap m/z ranges. However, as the deflector takes up some 20% of the ion path, problems may arise if both traps 30a, 30b are operating with relatively large m/z. In these embodiments, it is preferred for the trap carrying lower m/z ions to release ions first, followed by the high m/z ions, as this minimises the required delay time.

A large extension of the deflector 82, 83 may create space to add additional C-traps (i.e. more than two), although this would be at the cost of length and stacking of extraction delays. Thus, two traps may be the most practical arrangement.

### 2.3 Parallel Trap Array

A further set of embodiments comprises a parallel extraction trap array coupled to an Orbitrap™ mass analyser.

As with the MR-ToF embodiments, a parallel trap array avoids the need to be fed by a branched ion guide or an additional ion source. For Orbitrap™ mass analysers, unlike with the MR-ToF design, there is little space to recombine the two ion beams, particularly considering that the ion beams are relatively wide in the dimension that they must be moved across. It would be possible to heavily modify the deflector to work in two dimensions (e.g. by using a multipole with superimposed fields, or by sacrificing length to add a new deflection region), but this is somewhat challenging and will restrict transmission and mass range.

A more elegant solution is to ignore the requirement to combine the two ion beams altogether, by adding an additional entrance slot to the Orbitrap™ analyser. This is illustrated by FIG. 17. As shown in FIG. 17, first 30a and second 30b extraction C-traps are coupled to an Orbitrap™ analyser 40 via respective sets of injection optics 43a, 43b. The Orbitrap™ analyser 40 comprises two injection slots, with respective entrance deflectors 86a, 86b.

In these embodiments, the same injection optics from FIG. 13 may be used, either duplicated for each C-Trap, or preferably extended in width. Pumping slots can also be shared, although the extra gas load through to the Orbitrap™ analyser should be considered.

The centres of the C-Traps 30a, 30b should ideally be separated by the diameter of the Orbitrap™ analyser (20-30 mm), but where this is not possible the C-Traps 30a, 30b may be angled slightly so that each beam reaches the correct Orbitrap™ analyser entrance aperture, which should also be positioned accordingly.

FIG. 17 shows two C-Traps 30a, 30b separated by a single aperture mounted orthogonally to the trapping electrodes. However, it would also be possible to have some separating ion guide, or to define trapping regions with DC gradients, e.g. created by electrodes mounted parallel to the RF trapping electrodes.

These embodiments have an advantage in that the ions can be extracted from both traps 30a, 30b simultaneously. However, it may still be preferred to have some delay, e.g. to compress the ion arrival time spread beyond that achievable with a single trap (as with the back-to-back trap array).

In these embodiments, there may be less consequence in the trap m/z ranges overlapping, although optimum performance may still generally come with pre-separation of ions into non-overlapping m/z ranges with each m/z range being stored in its optimum trap. An additional resolving linear trap may be used to pre-separate masses into groups in each extraction trap (as described above), but to a limited extent this process may be achievable with just the parallel trap array. When, for a short period before extraction, the DC barrier separating the trapping regions is held at 2 or 3 times the average thermal temperature, ions of low m/z may disproportionately filter across due to the higher axial oscillation frequency. This could be improved with a small scanned RF or square wave RF added to the central aperture to excite ions of different m/z in a resonant manner and allow them across the aperture (i.e. parametric excitation).

In these embodiments, having more than two traps in series is possible, e.g. where the traps may be separated by curved ion guides to encircle the Orbitrap™ analyser. This, however, may be somewhat inelegant as duplicate sets of injection optics would be needed (or else large optics with some rotational symmetry), and the extra pumping requirements may be considerable.

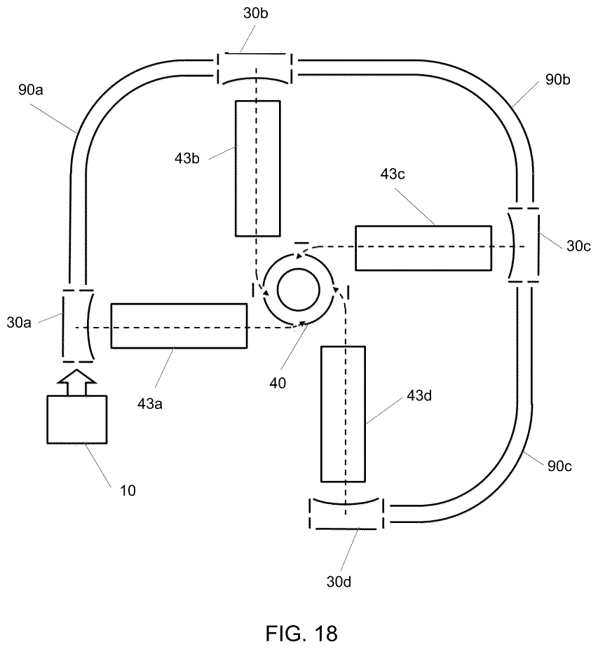

An example embodiment of such a configuration is shown in FIG. 18. As shown in FIG. 18, an extended parallel trap array is provided with each trap being coupled to one of multiple Orbitrap™ analyser injection ports. More particularly, four extraction traps 30a, 30b, 30c, 30d are provided and arranged to as to surround an Orbitrap™ analyser 40. Each extraction trap 30a, 30b, 30c, 30d is coupled to a respective injection port in the Orbitrap™ analyser 40 via a respective set of injection optics 43a, 43b, 43c, 43d. The extraction traps 30a, 30b, 30c, 30d may be coupled to one another via three curved ion guides 90a, 90b, 90c, such that each of the traps can be filled with ions from a single ion source 10.

The limits of this system lie in how well the Orbitrap™ analyser 40 field can be maintained with multiple entrance slots, and how the final lens and deflector parts of the injection optics 43a, 43b, 43c, 43d can be fit in. Nevertheless, up to four extraction traps appear to be possible.

It will be appreciated from the above that conventional arrangements in which a single extraction trap is coupled to a mass analyser have m/z range limitations created by the RF trapping conditions and the ion spatial and energy acceptance of the analyser. Space charge limitations also discriminate against high m/z ions further limiting mass range.

The multiple trap configurations described herein allow for the best of both worlds to be achieved, as low m/z performance becomes dominated by a trap configured for low m/z, and high m/z performance dominated by a trap configured for high m/z. Dynamic range also increases thanks to the presence of additional trapping volume, and still further, the high m/z ions will not be perturbed by the presence of large amounts of low m/z ions as their respective trapping volumes are separate.

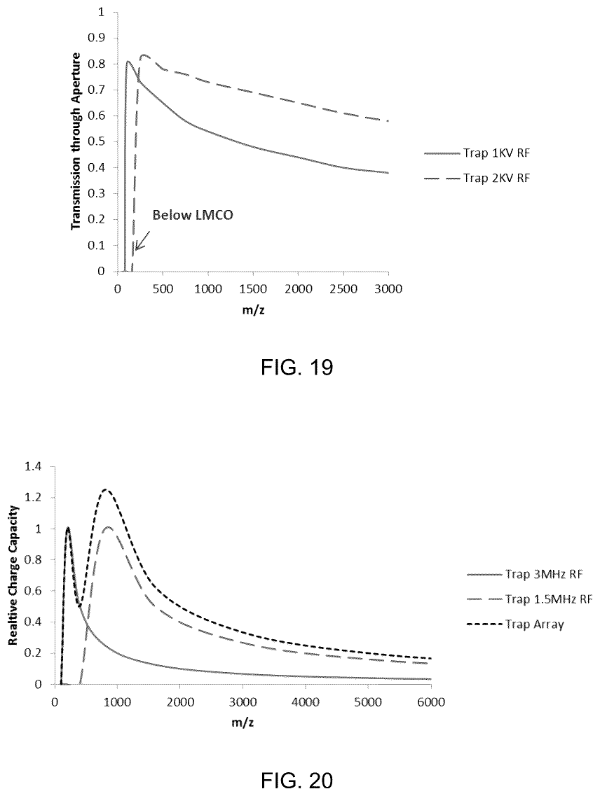

FIG. 19 shows a simulated example for the transmission of ions of different m/z through an MR-ToF analyser, from a single trap with two different RF voltages applied. As can be seen in FIG. 19, one of the voltages gives good high m/z transmission but low m/z ions fall below the low-mass-cut-off (LMCO), while the other voltage gives poor high m/z performance. FIG. 20 shows a second example of space charge performance for Orbitrap™ extraction traps, with the standard single 3 MHz RF and 1.5 MHz RF traps, as well as for an array combining these two traps. Thus, combining two or more traps using the embodiments described herein is clearly beneficial.

Another advantage of various embodiments, in the case of ToF analysers such as MR-ToF analysers, is the increase in scan rate made available by operating multiple traps sequentially. Thus, the extraction traps can be properly matched to the analyser, which is beneficial e.g. for the number of multiple reaction monitoring (MRM) channels per second (e.g. 200 for each trap, to 3 traps), and dynamic range.

It will be appreciated from the above that embodiments provide arrangements in which multiple extraction traps are used to improve the scan rate of a ToF analyser such as a MR-ToF analyser. Embodiments also provide arrangements in which multiple extraction traps are used with differing trapping conditions to broaden the m/z range of a mass analyser. Furthermore, embodiments provide various arrangements to couple multiple extraction trap arrays to mass analysers such as ToF and Orbitrap™ mass analysers.

Although the present invention has been described with reference to various embodiments, it will be understood that various changes may be made without departing from the scope of the invention as set out in the accompanying claims.

1. A method of operating an analytical instrument that comprises:
a mass analyser;
a first ion trap coupled to the mass analyser; and
a second ion trap coupled to the mass analyser;
the method comprising:
operating the first ion trap in a mode of operation in which the first ion trap confines ions having mass-to-charge ratios within a first m/z range, and storing first ions in the first ion trap;
operating the second ion trap in a mode of operation in which the second ion trap confines ions having mass-to-charge ratios within a second different m/z range, and storing second ions in the second ion trap;
ejecting the first ions from the first ion trap into the mass analyser;
ejecting the second ions from the second ion trap into the mass analyser; and
mass analysing the first ions and the second ions, wherein a combination of the first and second m/z ranges provides a wider m/z range than any one of the first and second m/z ranges alone.

2. The method of claim 1, wherein the instrument further comprises a third ion trap coupled to the mass analyser, and wherein the method further comprises:
operating the third ion trap in a mode of operation in which the third ion trap confines ions having mass-to-charge ratios within a third different m/z range, and storing third ions in the third ion trap;
ejecting the third ions from the third ion trap into the mass analyser; and
mass analysing the third ions, wherein the combination of the first, second and third m/z ranges collectively provides a wider m/z range than the combination of the first and second m/z ranges alone.

3. The method of claim 1, wherein the first and second m/z ranges are non-overlapping.

4. The method of claim 1, wherein:
operating the first ion trap in the mode of operation in which the first ion trap confines ions having mass to charge ratios within the first m/z range comprises applying to the first ion trap a first RF voltage having a first amplitude and a first frequency; and
operating the second ion trap in the mode of operation in which the second ion trap confines ions having mass to charge ratios within the second different m/z range comprises applying to the second ion trap a second RF voltage having a second amplitude and a second frequency;
wherein the second amplitude is different to the first amplitude; and/or
wherein the second frequency is different to the first frequency.

5. The method of claim 1, further comprise separating ions according to their m/z before the ions are stored in the first ion trap and/or the second ion trap.

6. The method of claim 1, wherein:
each ion trap has a trap axis, and wherein ions stored in each ion trap are ejected into the mass analyser in an extraction direction orthogonal to the trap axis;
a trap axis of the first trap is aligned with a trap axis of the second trap;
an extraction direction of the first trap is parallel to an extraction direction of the second trap; and
the instrument further comprises an array of trapping regions upstream of the first and second ion traps, and wherein the method comprises:
storing the first ions in a first trapping region of the array of trapping regions, and storing the second ions in a second trapping region of the array of trapping regions;
transferring the first ions from the first trapping region to the first ion trap, and transferring the second ions from the second trapping region to the second ion trap; and then
cooling the first ions in the first ion trap, and cooling the second ions in the second ion trap;
wherein the method comprises storing further ions in the array of trapping regions at the same time as cooling the first ions in the first ion trap and/or cooling the second ions in the second ion trap.

7. The method of claim 1, wherein the mass analyser is an electrostatic ion trap mass analyser.

8. The method of claim 1, wherein the mass analyser is a time-of-flight (ToF) mass analyser, and wherein the time-of-flight mass analyser comprises a plane corrector arranged upstream of an ion detector.

9. A method of operating an analytical instrument that comprises:
a time-of-flight mass analyser comprising an ion path, and an ion detector arranged at the end of the ion path;
a first ion trap coupled to the mass analyser; and
a second ion trap coupled to the mass analyser, wherein the first and second ion traps are arranged at the start of the ion path;
the method comprising:
(a)(i) storing first ions in the first ion trap, (a)(ii) cooling the first ions in the first ion trap, and then (a)(iii) ejecting the cooled first ions from the first ion trap into the ion path; and
(b)(i) storing second ions in the second ion trap, (b)(ii) cooling the second ions in the second ion trap, and then (b)(iii) ejecting the cooled second ions from the second ion trap into the ion path.

10. The method of claim 9, wherein the time-of-flight mass analyser comprises a plane corrector arranged upstream of the detector.

11. The method of claim 9, wherein:
each ion trap has a trap axis, and wherein ions stored in each ion trap are ejected into the mass analyser in an extraction direction orthogonal to the trap axis;
a trap axis of the first trap is aligned with a trap axis of the second trap;
an extraction direction of the first trap is parallel to an extraction direction of the second trap; and
the method comprises supplying the first ion trap with ions via the second ion trap.

12. The method of claim 11, wherein the instrument further comprises an array of trapping regions upstream of the first and second ion traps, and wherein the method comprises:
storing the first ions in a first trapping region of the array of trapping regions, and storing the second ions in a second trapping region of the array of trapping regions;
transferring the first ions from the first trapping region to the first ion trap, and transferring the second ions from the second trapping region to the second ion trap; and
then cooling the first ions in the first ion trap, and cooling the second ions in the second ion trap;
wherein the method comprises storing further ions in the array of trapping regions at the same time as cooling the first ions in the first ion trap and/or cooling the second ions in the second ion trap.

13. The method of claim 9, wherein:
each ion trap has a trap axis, and wherein ions stored in each ion trap are ejected into the mass analyser in an extraction direction orthogonal to the trap axis;
a trap axis of the first trap is parallel to a trap axis of the second trap; and
an extraction direction of the first trap is parallel to an extraction direction of the second trap;
wherein the method comprises (b)(i) storing the second ions in the second ion trap at the same time as (a)(ii) cooling the first ions in the first ion trap and/or at the same time as (a)(iii) ejecting the cooled first ions from the first ion trap into the ion path.

14. The method of claim 1, wherein:
each ion trap has a trap axis, and wherein ions stored in each ion trap are ejected into the mass analyser in an extraction direction orthogonal to the trap axis;
a trap axis of the first trap is parallel to a trap axis of the second trap;
an extraction direction of the first trap is aligned with an extraction direction of the second trap; and
the first ion trap and the second ion trap are coupled to the mass analyser via the same set of one or more ion optical devices.

15. The method of claim 14, wherein the instrument comprises a lens arranged between the first ion trap and the second ion trap.

16. The method of claim 14, wherein the instrument further comprises a branched ion guide configured to supply the first and second ion guides with ions.

17. The method of claim 1, wherein the instrument further comprises:
one or more first deflectors arranged downstream of the first and second ion traps, and one or more second deflectors arranged downstream of the one or more first deflectors;
wherein the one or more first deflectors are configured to cause ions ejected from the first and second ion traps to travel to the one or more second deflectors; and
wherein the one or more second deflectors are configured to direct ions into the mass analyser and/or to direct ions along an ion path of the mass analyser.

18. The method of claim 17, wherein the one or more second deflectors comprises a single deflector, and wherein the method comprises applying a first voltage to the second deflector when the second deflector receives ions from the first ion trap, and applying a second different voltage to the second deflector when the second deflector receives ions from the second ion trap.

19. The method of claim 1, wherein the mass analyser is an electrostatic ion trap mass analyser, and wherein the ion trap mass analyser comprises:
a first entrance aperture, and a second entrance aperture;
a first entrance deflector arranged adjacent to the first entrance aperture, and a second entrance deflector arranged adjacent to the second entrance aperture;
wherein the first entrance deflector is configured to direct ions from the first ion trap into the ion trap mass analyser via the first entrance aperture; and
wherein the second entrance deflector is configured to direct ions from the second ion trap into the ion trap mass analyser via the second entrance aperture.

20. An analytical instrument comprising:
a mass analyser;
a first ion trap coupled to the mass analyser;
a second ion trap coupled to the mass analyser; and
a control system configured to:
cause first ions to be stored in the first ion trap;
cause second ions to be stored in the second ion trap;
cause the first ions to be ejected from the first ion trap into the mass analyser;
cause the second ions to be ejected from the second ion trap into the mass analyser; and
cause the mass analyser to mass analyse the first ions and the second ions.
